(19) United States
(12) Patent Application Publication
(10) Pub. No.: US 2024/0017404 A1
(43) Pub. Date: Jan. 18, 2024

(54) ROBOT STEP LENGTH CONTROL METHOD, ROBOT CONTROLLER, AND COMPUTER-READABLE STORAGE MEDIUM

(71) Applicant: UBTECH ROBOTICS CORP LTD, Shenzhen (CN)

(72) Inventors: Chunyu Chen, Shenzhen (CN); Yizhang Liu, Shenzhen (CN); Ligang Ge, Shenzhen (CN); Zheng Xie, Shenzhen (CN); Youjun Xiong, Shenzhen (CN)

(21) Appl. No.: 18/371,472

(22) Filed: Sep. 22, 2023

Related U.S. Application Data
(63) Continuation of application No. PCT/CN2021/131142, filed on Nov. 16, 2021.

(30) Foreign Application Priority Data
Mar. 22, 2021 (CN) 202110304528.8

(51) Int. Cl. B25J 9/16

(52) U.S. Cl. CPC B25J 9/1628

(57) ABSTRACT

A robot step length control method, a robot controller, and a computer-readable storage medium are provided. The method includes: if it detects that a humanoid robot is not in a balanced state at a current time, it correspondingly obtains a torso deflection posture parameter, a lower limb parameter and a leg swing frequency of the legs of the humanoid robot at the current time; and it calculates, using a swinging leg capture point algorithm, a calculated step length for maintaining a stable state of the humanoid robot that meets a posture balance requirement of the robot at the current time based on the torso deflection posture parameter, the lower limb parameter, and the leg swing frequency, so that the humanoid robot can be restored to the balanced state after moving with the calculated step length, thereby improving the anti-interference ability of the robot.

### CROSS REFERENCE TO RELATED APPLICATIONS

The present disclosure is a continuation-application of International Application PCT/CN2021/131142, with an international filing date of Nov. 16, 2021, which claims foreign priority of Chinese Patent Application No. 202110304528.8, filed on Mar. 22, 2021 in the State Intellectual Property Office of China, the contents of all of which are hereby incorporated by reference.

### BACKGROUND

### 1. Technical Field

The present disclosure relates to robot control technology, and particularly to a robot step length control method, a robot controller, and a computer-readable storage medium.

### 2. Description of Related Art

With the continuous development of science and technology, robot technology has been widely valued by all walks of life because of its great values in researches and applications. In which, the control of humanoid robots is an important course for research. However, in actual control processes, humanoid robots are usually subject to external disturbances (e.g., pushes by external forces and external interferences of strong wind) and/or internal disturbances (e.g., increasement of the weight of robot head and disconnection of mechanical arm), hence there will have instability that the balanced state cannot be maintained.

### BRIEF DESCRIPTION OF THE DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a schematic block diagram of the structure of a robot control apparatus according to an embodiment of the present disclosure.

FIG. 2 is a schematic diagram of the movement of a humanoid robot according to an embodiment of the present disclosure.

FIG. 3 is a flow chart of the first example of a robot step length control method according to an embodiment of the present disclosure.

FIG. 4 is a schematic diagram of the force acting on the humanoid robot in the pitch direction according to an embodiment of the present disclosure.

FIG. 5 is a schematic diagram of the force acting on the humanoid robot in the roll direction according to an embodiment of the present disclosure.

FIG. 6 is a flow chart of the first example of the sub-steps included in step S230 of the robot step length control method in FIG. 3.

FIG. 7 is a flow chart of the second example of the sub-steps included in step S230 of the robot step length control method in FIG. 3.

FIG. 8 is a flow chart of the second example of a robot step length control method according to an embodiment of the present disclosure.

FIG. 9 is a schematic block diagram of the first example of the structure of a robot controller according to an embodiment of the present disclosure.

FIG. 10 is a schematic block diagram of the second example of the structure of a robot controller according to an embodiment of the present disclosure.

### DETAILED DESCRIPTION

In order to make the objects, technical solutions and advantages of the embodiments of the present disclosure more clear, the technical solutions in the embodiments of the present disclosure will be clearly and completely described below with reference to the drawings in the embodiments of the present disclosure. Apparently, the described embodiments are part of the embodiments of the present disclosure, not all of the embodiments. The components of the embodiments of the present disclosure that are described and illustrated in the drawings herein may generally be arranged and designed in a variety of different configurations.

Therefore, the following detailed description of the embodiments of the present disclosure provided in the drawings is not intended to limit the scope of the present disclosure, but merely represent the selected embodiments of the present disclosure. Based on the embodiments in the present disclosure, all other embodiments obtained by those of ordinary skill in the art without creative work fall within the protection scope of the present disclosure.

It should be noted that, in the following figures, similar numerals and letters refer to similar items. Therefore, once an item is defined in one figure, it does not require further definition and explanation in subsequent figures.

In the description of the present disclosure, it is to be understood that the orientational or positional relationship indicated by the terms “center”, “upper”, “lower”, “left”, “right”, “vertical”, “horizontal”, “inner”, “outer”, or the like is based on the orientational or positional relationship shown in the drawings, that in the usual placement of the product related to the present disclosure, or that commonly understood by those skilled in the art, and is merely for the convenience of describing the present disclosure and simplifying the description, rather than indicating or implying that the device or component referred to must have a particular orientation, be constructed and operated in a particular orientation, hence should not be understood as limitations to the present disclosure.

Besides, relational terms such as “first” and “second” are used only to distinguish one entity or operation from another entity or operation, and do not necessarily require or imply the existence of any actual relationship or sequence between these entities or operations. Moreover, the terms “comprising”. “including” or any other variation thereof are intended to encompass non-exclusive inclusion such that a process, method, article or apparatus (device) comprising a series of elements includes not only those elements, but also includes other elements not explicitly listed or inherent to the process, method, article or apparatus. Without further limitation, an element limited by the sentence “comprising a . . . ” does not preclude the existence of additional identical elements in a process, method, article or apparatus that includes the element. For those of ordinary skill in the art, the specific meanings of the above-mentioned terms in the present disclosure can be understood according to the specific condition.

Some embodiments of the present disclosure will be described in detail below with reference to the drawings. The following embodiments and the features therein may be combined with each other while there is no confliction therebetween

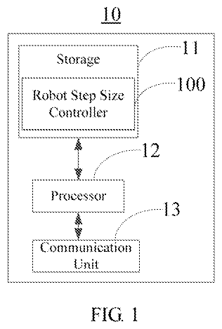

FIG. 1 is a schematic block diagram of the structure of a robot control apparatus 10 according to an embodiment of the present disclosure. As shown in FIG. 1, in this embodiment, the robot control apparatus 10 is configured to regulate the motion status of a humanoid robot, which may communicate with the humanoid robot in wireless manner, or be integrated with the humanoid robot so that the humanoid robot can calculate the required step length when the humanoid robot is out of balance and then control the humanoid robot to move with the calculated step length so that the humanoid robot can restore to the balanced state, thereby improving the anti-interference ability of the robot. The robot may have a torso and two legs coupled to the torso.

In this embodiment, the robot control apparatus 10 may include a storage 11, a processor 12, a communication unit 13, and a robot controller 100. The components of the storage 11, the processor 12 and the communication unit 13 are directly or indirectly electrically connected to each other to realize data transmission or interaction. For example, the components of the storage 11, the processor 12 and the communication unit 13 may be electrically connected to each other through one or more communication buses or signal lines.

In this embodiment, the storage 1 may be, but not limited to, a random access memory (RAM), a read only memory (ROM), a programmable read only memory (PROM), erasable programmable read-Only memory (EPROM), electrical erasable programmable read-only memory (EEPROM), or the like. In which, the storage 11 is used for storing computer programs, and the processor 12 can execute the computer programs correspondingly after receiving execution instructions.

In which, the storage 11 is also configured to pre-store the lower limb parameter of the humanoid robot. The lower limb parameter represents the overall size of the structure of the lower limb of the humanoid robot, which may include a leg length, a sole length, a sole width of the humanoid robot, and the like.

In this embodiment, the processor 12 may be an integrated circuit chip with signal processing capability. The processor 12 may be a general purpose processor including at least one of a central processing unit (CPU), a graphics processing unit (GPU), a network processor (NP), a digital signal processor (DSP), an application specific integrated circuit (ASIC), a field-programmable gate array (FPGA) or other programmable logic devices, discrete gate, transistor logic device, and discrete hardware component. The general purpose processor may be a microprocessor or the processor may also be any conventional processor that may implement or execute the methods, steps, and the logical block diagrams disclosed in the embodiments of the present disclosure.

In this embodiment, the communication unit 13 is used for establishing a communication connection between the robot control apparatus 10 and other electronic devices through a network, and for sending/receiving data through the network, where the network includes a wired communication and a wireless communication network. For example, through the communication unit 13, the robot control apparatus 10 may obtain expected motion trajectory information for the humanoid robot from a job planner, and transmit motion control instructions to the humanoid robot, thereby making the humanoid robot to move according to the motion control instructions.

In this embodiment, the robot step length controller 100 may include at least one software function module that can be stored in the storage 1I or in the operating system of the robot control apparatus 10 in the form of software or firmware. The processor 12 may be used to execute executable modules such as software function modules and computer programs included in the robot controller 100 that are stored in the storage 11. The robot control apparatus 10 may calculate, through the robot controller 100, the step length required for maintaining the stability of the humanoid robot when the humanoid robot loses its stability,

It can be understood that the composition of the robot control apparatus 10 in FIG. 1 is only an example of that of a robot control apparatus, and the robot control apparatus 10 may further include more or less elements than those shown in FIG. 1, or have a different configuration from that shown in FIG. 1. Each of the elements shown in FIG. 1 may be implemented in hardware, software, or a combination thereof.

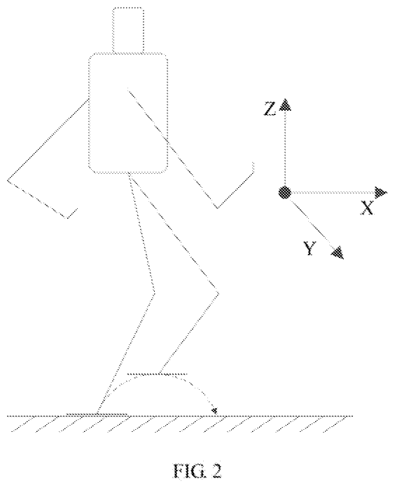

FIG. 2 is a schematic diagram of the movement of the humanoid robot according to an embodiment of the present disclosure. As shown in FIG. 2, the walking movement of the humanoid robot is described. In this embodiment, during the humanoid robot walks, the two legs of the humanoid robot will be a supporting leg and a swinging leg, respectively, where the supporting leg represents one of the legs that supports the entire torso of the humanoid robot, and the swinging leg represents the other of the legs that currently needs to change its moving trajectory (by swinging).

When the sole of the supporting leg of the humanoid robot contacts a ground, the ground may be taken as the origin of a world coordinate system to establish a Cartesian right-handed coordinate system, so that the forward direction of the X-axis represents the forward direction of the humanoid robot, and the forward direction of the Z-axis be vertical to the ground. At this time, the pitch plane formed by the X-axis and the Z-axis is the plane on which the humanoid robot can perform pitch angle changes, the roll plane formed by the Y-axis and the Z-axis is the plane on which the humanoid robot can perform roll angle changes; any direction within the pitch plane is the pitch direction for the humanoid robot to perform pitch motions, any direction within the roll plane is the roll direction for the humanoid robot to perform roll motions; and the included angle between the pitch direction and the forward direction of the Z axis is the pitch angle for the humanoid robot to perform the pitch motions, and the included angle between the roll direction and the forward direction of the Z axis is the roll angle for the humanoid robot to perform the roll motions.

In the present disclosure, in order to ensure that the robot control apparatus 10 can automatically calculate the step length required for maintaining the stability of the humanoid robot when the humanoid robot loses its stability, the humanoid robot can be restored to a balanced state correspondingly after moving with the calculated step length, thereby improving the anti-interference ability of the robot. In this embodiment a step length control method for a humanoid robot is provided to achieve the above-mentioned purpose, which will be described in detail below.

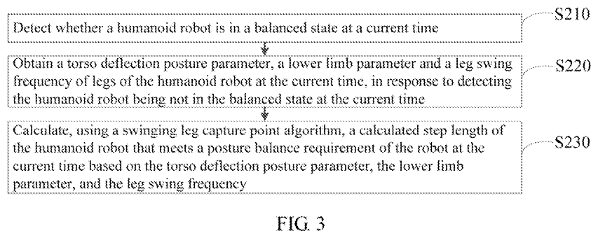

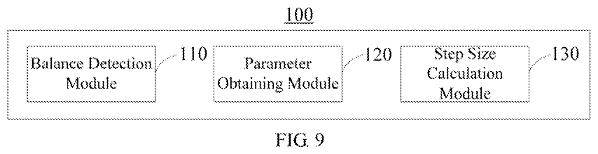

FIG. 3 is a flow chart of the first example of a robot step length control method according to an embodiment of the present disclosure. In this embodiment, a computer-implemented step length control method for a robot is provided. The robot has a torso and two legs coupled to the torso. The method may be implemented through the robot control apparatus shown in FIG. 1. In other embodiments, the robot step length control method may be applied on a robot controller shown in FIG. 9. As shown in FIG. 3, the robot step length control method may include steps S210-S230.

S210: detecting whether the humanoid robot is in a balanced state at a current time.

In this embodiment, the robot control apparatus 10 may obtain, through sensors installed on the humanoid robot such as force sensor and posture sensor, the motion state of the humanoid robot, then determine whether the humanoid robot is currently in the balanced state or not by analyzing the motion state.

For example, when the robot control apparatus 10 obtains the posture angle of the humanoid robot through the posture sensor, it may compare the obtained posture angle with a preset posture angle threshold. If the posture angle is larger than or equal to the preset posture angle threshold, the humanoid robot will be determined as currently not in the balanced state, otherwise, the humanoid robot will be determined as currently in the balanced state. When the robot control apparatus 10 detects, through the force sensor, the force acting on the humanoid robot, it may compare the obtained force with a preset force threshold. If the detected force is larger than or equal to the preset force threshold, the humanoid robot is determined as currently not in the balanced state; otherwise, the humanoid robot will be determined as currently in the balanced state.

S220: obtaining a torso deflection posture parameter, a lower limb parameter and a leg swing frequency of the legs of the humanoid robot at the current time, in response to detecting the humanoid robot being not in the balanced state at the current time.

In this embodiment, the torso deflection posture parameter represents the status of the deflection of the torso of the humanoid robot. In which, the torso deflection posture parameter may include the pitch angle and pitch angular velocity of the torso of the humanoid robot in the pitch direction, and the roll angle and roll angular velocity of the torso of the humanoid robot in the roll direction.

S230: calculating, using a swinging leg capture point algorithm, a calculated step length of the humanoid robot that meets a posture balance requirement of the robot at the current time based on the torso deflection posture parameter, the lower limb parameter, and the leg swing frequency.

In this embodiment, after the robot control apparatus 10 obtains the torso deflection posture parameter of the humanoid robot, the lower limb parameter and the leg swing frequency, at which the humanoid robot loses the stability, it may calculate, for the current swinging leg of the humanoid robot, the step length required for the swinging leg to cooperate with the supporting leg to ensure the balance of the robot, that is, the step length to be taken to meet the posture balance requirement, using the swinging leg capture point algorithm. In which, the step length to be taken may include a first step length of the humanoid robot in the pitch direction relative to the horizontal plane, and a second step length of the humanoid robot in the roll direction relative to the horizontal plane.

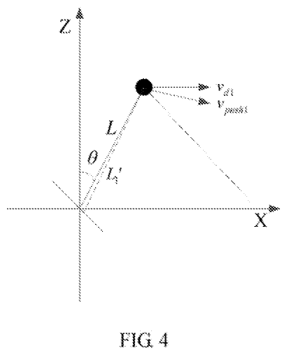

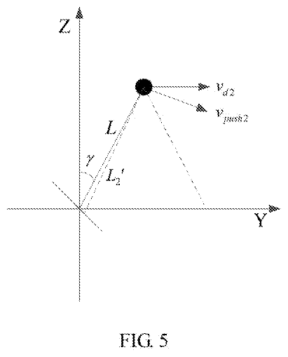

FIG. 4 is a schematic diagram of the force acting on the humanoid robot in the pitch direction according to an embodiment of the present disclosure; and FIG. 5 is a schematic diagram of the force acting on the humanoid robot in the roll direction according to an embodiment of the present disclosure. In which, the robot control apparatus 10 may use an inverted pendulum model to abstract the humanoid robot, so that all the masses of the humanoid robot are concentrated at the center of mass, while the two legs of the humanoid robot are taken as two massless telescopic rods of pendulum. In this case, the force-bearing state of the humanoid robot, when the humanoid robot loses its stability, can effectively expressed as in FIG. 4 and FIG. 5.

As shown in FIG. 4, in the force schematic diagram, the humanoid robot in an unstable state will subject to a force component of an instability force in the pitch direction along a posture change direction. At this time, the first target velocity of the humanoid robot in the pitch direction may be represented as an equation of

$$\{ \begin{matrix}{v}_{1} = {v}_{d 1} + {v}_{push 1} sin ( θ ) \\ {v}_{push 1} = {L}_{1}^{′} \dot{θ} \\ {L}_{1}^{′} = \sqrt{( {L}^{2} + {( l / 2 )}^{2} )}\end{matrix} ,$$

where \dot{θ} represents the pitch angular velocity of the torso of the humanoid robot in the pitch direction, θ represents the pitch angle of the torso of the humanoid robot in the pitch direction, L represents the leg length of the humanoid robot, l represents the sole lengths of the humanoid robot, v₁ represents a first target speed of the humanoid robot in the pitch direction, v_{d1} represents an expected velocity of the humanoid robot in the pitch direction, and vₚᵤₛₕ₁ represents the velocity generated by the humanoid robot under the force component corresponding to the pitch direction.

At this time, the equation for calculating the above-mentioned first target velocity may be constrained using the swinging leg capture point algorithm so as to obtain the first step length required by the humanoid robot in the pitch direction, so that the equation for calculating the above-mentioned first target velocity can be constrained on the basis of an equation

$${ξ}_{1} = x + \frac{\dot{x}}{ω}$$

representing the algorithm corresponding to the capture point algorithm. In which, ζ₁ represents a captured landing point of the humanoid robot in the pitch direction, x represents the distance component of the distance from the center of mass of an inverted pendulum to the support point of the robot on the pitch plane, x represents the differential of the change of the center of mass of the inverted pendulum in the pitch direction, and ω represents the leg swing frequency of the humanoid robot.

Therefore, in the equation

$${ξ}_{1} = x + \frac{\dot{x}}{ω}$$

representing the capture point algorithm, it may assume that ζ₁=0 to represent the current posture balance requirement of the humanoid robot. At this time, the above-mentioned equation representing the algorithm may be changed into a first step length related equation of

$$x = - \frac{\dot{x}}{ω} = - \frac{{v}_{1}}{ω} = - \frac{{v}_{d 1} + \sqrt{( {L}^{2} + {( l / 2 )}^{2} )} \dot{θ} sin ( θ )}{ω} ,$$

so as to obtain a step length calculation equation for calculating the first step length of the humanoid robot in the pitch direction relative to the horizontal plane, thereby calculating the first step length that meets the posture balance requirement.

As shown in the force schematic diagram of FIG. 5, the humanoid robot in the unstable state will subject to a force component of an instability force in the roll direction along the posture change direction. At this time, the second target velocity of the humanoid robot in the roll direction may be represented as an equation of

$$\{ \begin{matrix}{v}_{2} = {v}_{d 2} + {v}_{push 2} sin ( γ ) \\ {v}_{push 2} = {L}_{2}^{′} \dot{γ} \\ {L}_{2}^{′} = \sqrt{( {L}^{2} + {( d / 2 )}^{2} )}\end{matrix} .$$

In which, \dot{γ} represents the roll angular velocity of the torso of the humanoid robot in the roll direction, γ represents the roll angle of the torso of the humanoid robot in the roll direction, d represents the sole width of the humanoid robot, L represents the leg length of the humanoid robot, v₂ represents the second target velocity of the humanoid robot in the roll direction, v_{d2} represents an expected velocity of the humanoid robot in the roll direction, and vₚᵤₛₕ₂ represents the velocity generated by the humanoid robot under the force component corresponding to the roll direction.

At this time, the equation for calculating the above-mentioned second target velocity may be constrained using the swinging leg capture point algorithm so as to obtain the first step length required by the humanoid robot in the pitch direction, so that the equation for calculating the above-mentioned second target velocity can be constrained on the basis of an equation

$${ξ}_{2} = y + \frac{\dot{y}}{ω}$$

of the algorithm that corresponds to the capture point algorithm. In which, ζ₂ represents a captured landing point of the humanoid robot in the roll direction, y represents the distance component of the distance from the center of mass of the inverted pendulum to the support point of the robot on the roll plane, \dot{y} represents the differential of the change of the center of mass of the inverted pendulum in the roll direction, and ω represents the leg swing frequency of the humanoid robot.

Therefore, in the equation

$${ξ}_{2} = y + \frac{\dot{y}}{ω}$$

representing the capture point algorithm, it may assume that ζ₂=0 to represent the current posture balance requirement of the humanoid robot. At this time, the above-mentioned equation representing the algorithm may be changed into a second step length related equation of

$$y = - \frac{\dot{y}}{ω} = - \frac{{v}_{2}}{ω} = - \frac{{v}_{d 2} + \sqrt{( {L}^{2} + {( d / 2 )}^{2} )} \dot{γ} sin ( γ )}{ω} ,$$

so as to obtain a step length calculation equation for calculating the second step length of the humanoid robot in the pitch direction relative to the horizontal plane, thereby calculating the second step length that meets the posture balance requirement.

Therefore, in the present disclosure, it may calculate the step length required for maintaining stability for the humanoid robot losing its stability by executing the above-mentioned steps S210-S230, so that the humanoid robot can restore to the balanced state after moving with the calculated step length, thereby improving the anti-interference ability of the robot.

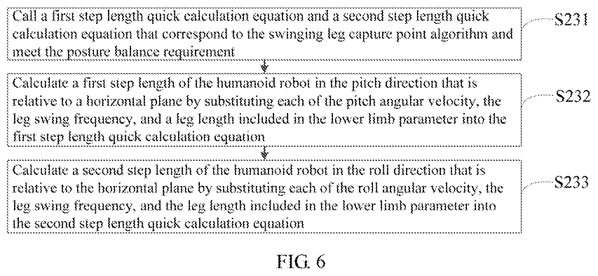

FIG. 6 is a flow chart of the first example of the sub-steps included in step S230 of the robot step length control method in FIG. 3. As shown in FIG. 6, in this embodiment, the step S230 may include sub-steps S231-S233, so as to achieve the purpose of quickly calculating the step length required for maintaining stability by executing the sub-steps S231-S233.

S231: calling a first step length quick calculation equation and a second step length quick calculation equation that correspond to the swinging leg capture point algorithm and meet the posture balance requirement.

In this embodiment, in order to achieve the purpose of quickly calculating the step length required for maintaining stability, after the robot control apparatus 10 determines that the first step length related equation and the second step length related equation that meet the posture balance requirement are obtained, the two equations may be directly converted after ignoring the sole length and the sole width in the two equations, so as to obtain the first step length quick calculation equation corresponding to the first step length related equation and the second step length quick calculation equation corresponding to the second step length related equation that have fewer required calculation parameters.

At this time, the first step length quick calculation equation may be expressed as

$$Δ x = - \frac{L \dot{θ}}{ω} ,$$

and the second step length quick calculation equation may be expressed as

$$Δ y = - \frac{L \dot{γ}}{ω} ,$$

where Δx represents the first step length,

$$Δ y = - \frac{L \dot{γ}}{ω}$$

represents the second step length, L represents the leg length of the humanoid robot, ω represents the leg swing frequency of the humanoid robot, \dot{θ} represents the pitch angular velocity, and \dot{γ} represents the roll angular velocity.

S232: calculating a first step length of the humanoid robot in the pitch direction that is relative to a horizontal plane by substituting each of the pitch angular velocity, the leg swing frequency, and a leg length included in the lower limb parameter into the first step length quick calculation equation.

S233: calculating a second step length of the humanoid robot in the roll direction that is relative to the horizontal plane by substituting each of the roll angular velocity, the leg swing frequency, and the leg length included in the lower limb parameter into the second step length quick calculation equation.

In this manner, in the present disclosure, it may directly store the first step quick calculation equation and the second step length quick calculation equation that require few kinds of calculation parameters in advance, then calculate the step length required for maintaining stability in a quick manner by directly using the pitch angular velocity and roll angular velocity included in the torso deflection posture parameter, the leg length included in the lower limb parameter, and the leg swing frequency.

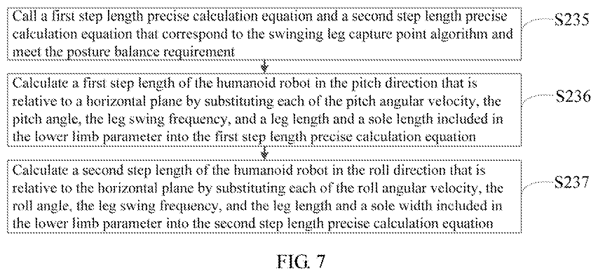

FIG. 7 is a flow chart of the second example of the sub-steps included in step S230 of the robot step length control method in FIG. 3. As shown in FIG. 7, in this embodiment, the step S230 may include sub-steps S235-S237, so as to achieve the purpose of accurately calculating the step length required for maintaining stability by executing sub-steps S235-S237.

S235: calling a first step length precise calculation equation and a second step length precise calculation equation that correspond to the swinging leg capture point algorithm and meet the posture balance requirement.

In this embodiment, in sake of accurately calculating the step length required for maintaining stability, after the robot control apparatus 10 determines that the first step length related equation and the second step length related equation that meet the posture balance requirement are obtained, the equations may be directly converted so as to obtain the first step length precise calculation equation corresponding to the first step related equation and the second step length precise calculation equation corresponding to the second step length related equation.

At this time, the first step precise calculation equation is expressed as

$$Δ x = \frac{\sqrt{( {L}^{2} + {( l / 2 )}^{2}} \dot{θ} sin ( θ )}{ω} ,$$

and the second step length precise calculation equation is expressed as

$$Δ y = \frac{\sqrt{( {L}^{2} + {( d / 2 )}^{2} )} \dot{γ} sin ( γ )}{ω} .$$

In which, Δx represents the first step length, Δy represents the second step length, L represents the leg length of the humanoid robot, ω represents the leg swing frequency of the humanoid robot, \dot{θ} represents the pitch angular velocity, θ represents the pitch angle, \dot{γ} represents the roll angular velocity, l represent the roll angle, l represent the sole length of the humanoid robot, and d represents the sole width of the humanoid robot.

S236: calculating a first step length of the humanoid robot in the pitch direction that is relative to a horizontal plane by substituting each of the pitch angular velocity, the pitch angle, the leg swing frequency, and a leg length and a sole length included in the lower limb parameter into the first step length precise calculation equation.

S237: calculating a second step length of the humanoid robot in the roll direction that is relative to the horizontal plane by substituting each of the roll angular velocity, the roll angle, the leg swing frequency, and the leg length and a sole width included in the lower limb parameter into the second step length precise calculation equation.

In this manner, in the present disclosure, it may store the first step precise calculation equation and the second step length precise calculation equation that have many kinds of required calculation parameters in advance, and calculate the step length required for maintaining stability in an accurate manner by directly using the pitch angle, the pitch angular velocity, the roll angle and the roll angular velocity included in the torso deflection posture parameter, the leg length, the sole length and the sole width included in the lower limb parameter, and the leg swing frequency.

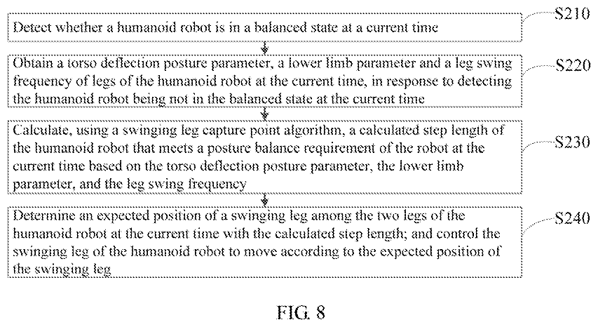

FIG. 8 is a flow chart of the second example of a robot step length control method according to an embodiment of the present disclosure. As shown in FIG. 8, in this embodiment, compared with the method for controlling the robot step length shown in FIG. 3, the method for controlling the robot step length shown in FIG. 8 may further include step S240.

S240: determining an expected position of a swinging leg among the two legs of the humanoid robot at the current time with the calculated step length; and controlling the swinging leg of the humanoid robot to move according to the expected position of the swinging leg.

In this embodiment, after the robot control apparatus 10 determines the step length to be taken for the humanoid robot to restore balance, it will determine, in the current Cartesian right-hand coordinate system, the corresponding desired position of the end of the swinging leg after the swing leg of the humanoid robot steps with the calculated step length, then the angle of each joint of the humanoid robot that is required to reach the desired position of the end of the swinging leg is solved using inverse kinematics so as to input the solved angle of each joint to the humanoid robot for adjusting the status of the joint, so that the current swinging leg of the humanoid robot can be moved normally to the desired position of the end of the swinging leg. In this manner, the humanoid robot can recover from the unstable state to the balanced state, which improves the anti-interference ability of the robot.

Therefore, in the present disclosure, by executing the above-mentioned step S240, it enables the current swinging leg of the humanoid robot to move normally to the position required to restore the balanced state so that the humanoid robot can recover from the unstable state to the balanced state, thereby improving the anti-interference ability of the robot.

In the present disclosure, in order to ensure that the robot control apparatus 10 can execute the above-mentioned robot step control method through the robot step controller 100, the above-mentioned functions are implemented by dividing the robot step controller 100 into functional modules. The specific composition of the robot step length controller 100 provided in the present disclosure will be described accordingly as follows.

FIG. 9 is a schematic block diagram of the first example of the structure of a robot step length controller according to an embodiment of the present disclosure. As shown in FIG. 9, in this embodiment, the robot step length controller 100 may include a balance detection module 110, a parameter obtaining module 120, and a step length calculation module 130.

The balance detection module 110 is configured to detect whether the humanoid robot is in a balanced state at a current time.

The parameter obtaining module 120 is configured to obtain a torso deflection posture parameter, a lower limb parameter and a leg swing frequency of the legs of the humanoid robot at the current time, in response to detecting the humanoid robot being not in the balanced state at the current time.

The step length calculation module 130 is configured to calculate, using a swinging leg capture point algorithm, a calculated step length of the humanoid robot that meets a posture balance requirement of the robot at the current time based on the torso deflection posture parameter, the lower limb parameter, and the leg swing frequency.

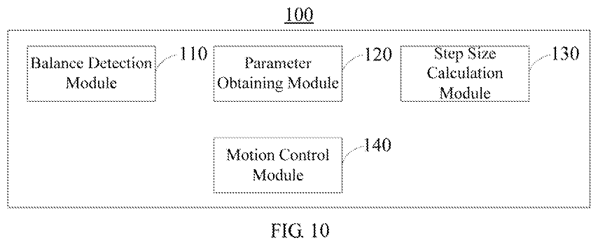

FIG. 10 is a schematic block diagram of the second example of the structure of a robot step length control apparatus according to an embodiment of the present disclosure. As shown in FIG. 10, in this embodiment, the robot step length controller 100 may further include a motion control module 140.

The motion control module 140 is configured to determine an expected position of a swinging leg among the two legs of the humanoid robot at the current time with the calculated step length; and control the swinging leg of the humanoid robot to move according to the expected position of the swinging leg.

It should be noted that the basic theories and technical effects of the robot step length controller 100 provided in this embodiment are the same as the that of the above-mentioned robot step length control method. For a brief description, for parts not mentioned, reference may be made to the above-mentioned description of the robot step length control method.

In the embodiments of the present disclosure, it should be understood that the disclosed apparatus (device) and method may be implemented in other manners. The above-mentioned apparatus embodiment is merely illustrative, for example, the flow charts and block diagrams in the drawings show the architecture, functions and operations that are possible to be implemented by the apparatus, method and computer program products of the embodiments. In this regard, each block in the flowchart or block diagram may represent a module, a program segment, or a part of codes that include one or more computer executable instructions for implementing specified logical functions. It should also be noted that, in some alternative implementations, the functions noted in the blocks may occur out of the order noted in the figures. For example, two blocks in succession may, in fact, be executed substantially concurrently, or may sometimes be executed in the reverse order, depending upon the functionality involved. It is also to be noted that each block in the block diagrams and/or flow charts, and the combination of blocks in the block diagrams and/or flow charts, may be implemented by a dedicated hardware-based system for performing the specified function or action, or may be implemented by a combination of special purpose hardware and computer instructions.

In addition, each functional module in each of the embodiments of the present disclosure may be integrated to form an independent part, each module or unit may exist independently, or two or more modules or units may be integrated to form an independent part. The functions can be stored in a computer-readable computer readable storage medium if it is implemented in the form of a software functional unit and sold or utilized as a separate product. Based on this understanding, the technical solution of the present disclosure, either essentially or in part, contributes to the prior art, or a part of the technical solution can be embodied in the form of a software product. The software product is stored in a storage medium, which includes a number of instructions for enabling a computer device (which can be a personal computer, a server, a network device, etc.) to execute all or a part of the steps of the methods described in each of the embodiments of the present disclosure. The above-mentioned storage medium includes a variety of media such as a USB disk, a mobile hard disk, a read-only memory (ROM), a random access memory (RAM), a magnetic disk, and an optical disk which is capable of storing program codes.

To sum up, in the robot step length control method, the robot controller, and the computer-readable storage medium provided by the present disclosure, if it detects that a humanoid robot is not in a balanced state at a current time, it correspondingly obtains a torso deflection posture parameter, a lower limb parameter and a leg swing frequency of the legs of the humanoid robot at the current time; and it calculates, using a swinging leg capture point algorithm, a calculated step length for maintaining a stable state of the humanoid robot that meets a posture balance requirement of the robot at the current time based on the torso deflection posture parameter, the lower limb parameter, and the leg swing frequency, so that the humanoid robot can be restored to the balanced state after moving with the calculated step length, thereby improving the anti-interference ability of the robot.

The foregoing are only some embodiments of the present disclosure, and are not intended to limit thereto. For those skilled in the art, the present disclosure may have various modifications and variations. Any modifications, equivalent replacements, improvements, and the like made within the spirit and principles of the present disclosure should be included within the scope of the present disclosure.

What is claimed is:

1. A computer-implemented step length control method for a humanoid robot having two legs, comprising:
detecting whether the humanoid robot is in a balanced state at a current time;
obtaining a torso deflection posture parameter, a lower limb parameter and a leg swing frequency of the legs of the humanoid robot at the current time, in response to detecting the humanoid robot being not in the balanced state at the current time;
calculating, using a swinging leg capture point algorithm, a calculated step length of the humanoid robot that meets a posture balance requirement of the robot at the current time based on the torso deflection posture parameter, the lower limb parameter, and the leg swing frequency; and
controlling the swinging leg among the legs of the humanoid robot at the current time to move based on the calculated step length;
wherein, the swinging leg capture point algorithm is represented as, for the posture balance requirement, equations of:
$$\{ \begin{matrix}{ξ}_{1} = x + \frac{\dot{x}}{ω} = 0 \\ {ξ}_{2} = y + \frac{\dot{y}}{ω} = 0\end{matrix} ;$$
where, ζ₁ represents a captured landing point of the humanoid robot in a pitch direction, x represents a distance component of the distance from the center of mass of an inverted pendulum of the humanoid robot to a support point of the humanoid robot on a pitch plane, \dot{x} represents the differential of the change of the center of mass of the inverted pendulum in the pitch direction, ζ₂ represents a captured landing point of the humanoid robot in a roll direction, y represents a distance component of the distance from the center of mass of the inverted pendulum to the support point of the robot on a roll plane, \dot{y} represents the differential of the change of the center of mass of the inverted pendulum in the roll direction, and ω represent the leg swing frequency.

2. The method of claim 1, wherein the torso deflection posture parameter includes a pitch angular velocity of a torso of the humanoid robot that is coupled to the two legs in a pitch direction and a roll angular velocity of the torso of the humanoid robot in a roll direction, and calculating, using the swinging leg capture point algorithm, the calculated step length of the humanoid robot that meets the posture balance requirement of the robot at the current time based on the torso deflection posture parameter, the lower limb parameter, and the leg swing frequency comprises:
calculating a first step length of the humanoid robot in the pitch direction that is relative to a horizontal plane by substituting each of the pitch angular velocity, the leg swing frequency, and a leg length included in the lower limb parameter into a first step length quick calculation equation, wherein the first step length quick calculation equation corresponds to the swinging leg capture point algorithm and meets the posture balance requirement; and
calculating a second step length of the humanoid robot in the roll direction that is relative to the horizontal plane by substituting each of the roll angular velocity, the leg swing frequency, and the leg length included in the lower limb parameter into a second step length quick calculation equation, wherein the second step length quick calculation equation corresponds to the swinging leg capture point algorithm and meets the posture balance requirement.

3. The method of claim 2, wherein the first step long quick calculation equation is represented as an equation of
$$Δ x = - \frac{L \dot{θ}}{ω} ,$$
and the second step long quick calculation equation is represented as an equation of
$$Δ y = - \frac{L \dot{γ}}{ω} ,$$
where Δx represents the first step length, Δy represent the second step length, L represents the leg length of the humanoid robot, and ω represents the leg swing frequency of the humanoid robot, \dot{θ} represents the pitch angular velocity, and \dot{γ} represents the roll angular velocity.

4. The method of claim 1, wherein the torso deflection posture parameter includes a pitch angle and a pitch angular velocity of the torso of the humanoid robot in a pitch direction and a roll angle and a roll angular velocity of the torso of the humanoid robot in a roll direction, and calculating, using the swinging leg capture point algorithm, the calculated step length of the humanoid robot that meets the posture balance requirement of the robot at the current time based on the torso deflection posture parameter, the lower limb parameter, and the leg swing frequency comprises:
calculating a first step length of the humanoid robot in the pitch direction that is relative to a horizontal plane by substituting each of the pitch angular velocity, the pitch angle, the leg swing frequency, and a leg length and a sole length included in the lower limb parameter into a first step length precise calculation equation, wherein the first step length precise calculation equation corresponds to the swinging leg capture point algorithm and meets the posture balance requirement; and
calculating a second step length of the humanoid robot in the roll direction that is relative to the horizontal plane by substituting each of the roll angular velocity, the roll angle, the leg swing frequency, and the leg length and a sole width included in the lower limb parameter into a second step length precise calculation equation, wherein the second step length precise calculation equation corresponds to the swinging leg capture point algorithm and meets the posture balance requirement.

5. The method of claim 4, wherein the first step long precise calculation equation is represented as an equation of
$$Δ x = - \frac{L \dot{θ}}{ω} ,$$
and the second step long precise calculation equation is represented as an equation of
$$Δ y = - \frac{L \dot{γ}}{ω} ,$$
where Δx represents the first step length, Δy represent the second step length, L represents the leg length of the humanoid robot, and ω represents the leg swing frequency of the humanoid robot, \dot{θ} represents the pitch angular velocity, θ represents the pitch angle, \dot{γ} represents the roll angular velocity, γ represents the roll angle, l represents the sole length, and d represents the sole width.

6. The method of claim 1, wherein controlling the swinging leg among the legs of the humanoid robot at the current time to move based on the calculated step length comprises:
determining an expected position of a swinging leg among the two legs of the humanoid robot at the current time with the calculated step length; and
controlling the swinging leg of the humanoid robot to move according to the expected position of the swinging leg.

7. A robot controller, comprising:
a processor;
a memory coupled to the processor; and
one or more computer programs stored in the memory and executable on the processor;
wherein, the one or more computer programs comprise:
instructions for detecting whether the humanoid robot is in a balanced state at a current time;
instructions for obtaining a torso deflection posture parameter, a lower limb parameter and a leg swing frequency of two legs of the humanoid robot at the current time, in response to detecting the humanoid robot being not in the balanced state at the current time;
instructions for calculating, using a swinging leg capture point algorithm, a calculated step length of the humanoid robot that meets a posture balance requirement of the robot at the current time based on the torso deflection posture parameter, the lower limb parameter, and the leg swing frequency; and
instructions for controlling the swinging leg among the legs of the humanoid robot at the current time to move based on the calculated step length;
wherein, the swinging leg capture point algorithm is represented as, for the posture balance requirement, equations of:
$$\{ \begin{matrix}{ξ}_{1} = x + \frac{\dot{x}}{ω} = 0 \\ {ξ}_{2} = y + \frac{\dot{y}}{ω} = 0\end{matrix} ;$$
where, ζ₁ represents a captured landing point of the humanoid robot in a pitch direction, x represents a distance component of the distance from the center of mass of an inverted pendulum of the humanoid robot to a support point of the humanoid robot on a pitch plane, \dot{x} represents the differential of the change of the center of mass of the inverted pendulum in the pitch direction, ζ₂ represents a captured landing point of the humanoid robot in a roll direction, y represents a distance component of the distance from the center of mass of the inverted pendulum to the support point of the robot on a roll plane, \dot{y} represents the differential of the change of the center of mass of the inverted pendulum in the roll direction, and ω represent the leg swing frequency.

8. The robot of claim 7, wherein the torso deflection posture parameter includes a pitch angular velocity of a torso of the humanoid robot that is coupled to the two legs in a pitch direction and a roll angular velocity of the torso of the humanoid robot in a roll direction; and calculating, using the swinging leg capture point algorithm, the calculated step length of the humanoid robot that meets the posture balance requirement of the robot at the current time based on the torso deflection posture parameter, the lower limb parameter, and the leg swing frequency comprises:
calculating a first step length of the humanoid robot in the pitch direction that is relative to a horizontal plane by substituting each of the pitch angular velocity, the leg swing frequency, and a leg length included in the lower limb parameter into a first step length quick calculation equation, wherein the first step length quick calculation equation corresponds to the swinging leg capture point algorithm and meets the posture balance requirement; and
calculating a second step length of the humanoid robot in the roll direction that is relative to the horizontal plane by substituting each of the roll angular velocity, the leg swing frequency, and the leg length included in the lower limb parameter into a second step length quick calculation equation, wherein the second step length quick calculation equation corresponds to the swinging leg capture point algorithm and meets the posture balance requirement.

9. The robot of claim 8, wherein the first step long quick calculation equation is represented as an equation of
$$Δ x = - \frac{L \dot{θ}}{ω} ,$$
and the second step long quick calculation equation is represented as an equation of
$$Δ x = - \frac{L \dot{γ}}{ω} ,$$
where Δx represents the first step length, Δy represent the second step length, L represents the leg length of the humanoid robot, and ω represents the leg swing frequency of the humanoid robot, \dot{θ} represents the pitch angular velocity, and \dot{γ} represents the roll angular velocity.

10. The robot of claim 7, wherein the torso deflection posture parameter includes a pitch angle and a pitch angular velocity of the torso of the humanoid robot in a pitch direction and a roll angle and a roll angular velocity of the torso of the humanoid robot in a roll direction, and calculating, using the swinging leg capture point algorithm, the calculated step length of the humanoid robot that meets the posture balance requirement of the robot at the current time based on the torso deflection posture parameter, the lower limb parameter, and the leg swing frequency comprises:
calculating a first step length of the humanoid robot in the pitch direction that is relative to a horizontal plane by substituting each of the pitch angular velocity, the pitch angle, the leg swing frequency, and a leg length and a sole length included in the lower limb parameter into a first step length precise calculation equation, wherein the first step length precise calculation equation corresponds to the swinging leg capture point algorithm and meets the posture balance requirement; and
calculating a second step length of the humanoid robot in the roll direction that is relative to the horizontal plane by substituting each of the roll angular velocity, the roll angle, the leg swing frequency, and the leg length and a sole width included in the lower limb parameter into a second step length precise calculation equation, wherein the second step length precise calculation equation corresponds to the swinging leg capture point algorithm and meets the posture balance requirement.

11. The robot of claim 10, wherein the first step long precise calculation equation is represented as an equation of
$$Δ y = - \frac{L \dot{θ}}{ω} ,$$
and the second step long precise calculation equation is represented as an equation of
$$Δ y = - \frac{L \dot{γ}}{ω} ,$$
where Δx represents the first step length, Δy represent the second step length, L, represents the leg length of the humanoid robot, and ω represents the leg swing frequency of the humanoid robot, \dot{θ} represents the pitch angular velocity, θ represents the pitch angle, \dot{γ} represents the roll angular velocity, γ represents the roll angle, l represents the sole length, and d represents the sole width.

12. The robot of claim 7, wherein controlling the swinging leg among the legs of the humanoid robot at the current time to move based on the calculated step length comprises:
determining an expected position of a swinging leg among the two legs of the humanoid robot at the current time with the calculated step length; and
controlling the swinging leg of the humanoid robot to move according to the expected position of the swinging leg.

13. A non-transitory computer-readable storage medium for storing one or more computer programs, wherein the one or more computer programs comprise:
instructions for detecting whether a humanoid robot is in a balanced state at a current time, wherein the humanoid robot has two legs;
instructions for obtaining a torso deflection posture parameter, a lower limb parameter and a leg swing frequency of the legs of the humanoid robot at the current time, in response to detecting the humanoid robot being not in the balanced state at the current time;
instructions for calculating, using a swinging leg capture point algorithm, a calculated step length of the humanoid robot that meets a posture balance requirement of the robot at the current time based on the torso deflection posture parameter, the lower limb parameter, and the leg swing frequency; and
instructions for controlling the swinging leg among the legs of the humanoid robot at the current time to move based on the calculated step length;
wherein, the swinging leg capture point algorithm is represented as, for the posture balance requirement, equations of:
$$\{ \begin{matrix}{ξ}_{1} = x + \frac{\dot{x}}{ω} = 0 \\ {ξ}_{2} = y + \frac{\dot{y}}{ω} = 0\end{matrix} ;$$
where, ζ₁ represents a captured landing point of the humanoid robot in a pitch direction, x represents a distance component of the distance from the center of mass of an inverted pendulum of the humanoid robot to a support point of the humanoid robot on a pitch plane, x represents the differential of the change of the center of mass of the inverted pendulum in the pitch direction, ζ₂ represents a captured landing point of the humanoid robot in a roll direction, y represents a distance component of the distance from the center of mass of the inverted pendulum to the support point of the robot on a roll plane, \dot{γ} represents the differential of the change of the center of mass of the inverted pendulum in the roll direction, and ω represent the leg swing frequency.

14. The storage medium of claim 13, wherein the torso deflection posture parameter includes a pitch angular velocity of a torso of the humanoid robot that is coupled to the two legs in a pitch direction and a roll angular velocity of the torso of the humanoid robot in a roll direction, and calculating, using the swinging leg capture point algorithm, the calculated step length of the humanoid robot that meets the posture balance requirement of the robot at the current time based on the torso deflection posture parameter, the lower limb parameter, and the leg swing frequency comprises:
calculating a first step length of the humanoid robot in the pitch direction that is relative to a horizontal plane by substituting each of the pitch angular velocity, the leg swing frequency, and a leg length included in the lower limb parameter into a first step length quick calculation equation, wherein the first step length quick calculation equation corresponds to the swinging leg capture point algorithm and meets the posture balance requirement; and
calculating a second step length of the humanoid robot in the roll direction that is relative to the horizontal plane by substituting each of the roll angular velocity, the leg swing frequency, and the leg length included in the lower limb parameter into a second step length quick calculation equation, wherein the second step length quick calculation equation corresponds to the swinging leg capture point algorithm and meets the posture balance requirement.

15. The storage medium of claim 14, wherein the first step long quick calculation equation is represented as an equation of
$$Δ x = - \frac{L \dot{θ}}{ω} ,$$
and the second step long quick calculation equation is represented as an equation of
$$Δ y = - \frac{L \dot{γ}}{ω} ,$$
where Δx represents the first step length, Δy represent the second step length, L represents the leg length of the humanoid robot, and ω represents the leg swing frequency of the humanoid robot, \dot{θ}represents the pitch angular velocity, and \dot{γ} represents the roll angular velocity.

16. The storage medium of claim 13, wherein the torso deflection posture parameter includes a pitch angle and a pitch angular velocity of the torso of the humanoid robot in a pitch direction and a roll angle and a roll angular velocity of the torso of the humanoid robot in a roll direction, and calculating, using the swinging leg capture point algorithm, the calculated step length of the humanoid robot that meets the posture balance requirement of the robot at the current time based on the torso deflection posture parameter, the lower limb parameter, and the leg swing frequency comprises:
calculating a first step length of the humanoid robot in the pitch direction that is relative to a horizontal plane by substituting each of the pitch angular velocity, the pitch angle, the leg swing frequency, and a leg length and a sole length included in the lower limb parameter into a first step length precise calculation equation, wherein the first step length precise calculation equation corresponds to the swinging leg capture point algorithm and meets the posture balance requirement; and
calculating a second step length of the humanoid robot in the roll direction that is relative to the horizontal plane by substituting each of the roll angular velocity, the roll angle, the leg swing frequency, and the leg length and a sole width included in the lower limb parameter into a second step length precise calculation equation, wherein the second step length precise calculation equation corresponds to the swinging leg capture point algorithm and meets the posture balance requirement.

17. The storage medium of claim 16, wherein the first step long precise calculation equation is represented as an equation of
$$Δ x = - \frac{L \dot{θ}}{ω} ,$$
and the second step long precise calculation equation is represented as an equation of
$$Δ y = - \frac{L \dot{γ}}{ω} ,$$
where Δx represents the first step length, Δy represent the second step length, L represents the leg length of the humanoid robot, and ω represents the leg swing frequency of the humanoid robot, \dot{θ} represents the pitch angular velocity, θ represents the pitch angle, \dot{γ} represents the roll angular velocity, γ represents the roll angle, l represents the sole length, and d represents the sole width.

18. The storage medium of claim 13, wherein controlling the swinging leg among the legs of the humanoid robot at the current time to move based on the calculated step length comprises:
determining an expected position of a swinging leg among the two legs of the humanoid robot at the current time with the calculated step length; and
controlling the swinging leg of the humanoid robot to move according to the expected position of the swinging leg.
